(19) United States
(12) Patent Application Publication
(10) Pub. No.: US 2007/0159133 A1
(43) Pub. Date: Jul. 12, 2007

(54) Battery Charger

(75) Inventors: Donwoong Kang, Camillus, NY (US); Scott W. Osiecki, Skaneateles, NY (US)

Correspondence Address: Michael C. Pophal;Eveready Battery Company, Inc., 25225 Detroit Road, Westlake, OH, 44145, US

(73) Assignee: Eveready Battery Company, Inc., Westlake, OH (US)

(21) Appl. No.: 11/328,663

(22) Filed: Jan. 10, 2006

(51) Int. Cl. H02J 7/00

(52) U.S. Cl. 320/107

(57) ABSTRACT

A battery charger (100) includes a housing (102), a battery compartment (104) which receives one or more batteries to be charged, and faceplate or skin (108). The faceplate (108) covers a portion of the charger (100) which is ordinarily visible during operation of the device. The faceplate (108) is readily replaceable to as to facilitate the alteration of a decorative appearance of the charger (100).

### BACKGROUND

The present invention relates primarily to battery chargers.

Recent years have seen a proliferation of battery powered electrical devices. Digital cameras, personal digital assistants (PDAs), hand held games, portable audio players, remote controls devices, wireless computer keyboards and mice, and mobile telephones are but a few examples of these devices.

Rechargeable (secondary) batteries, such as nickel-metal hydride (Ni-MH), nickel-cadmium (Ni—Cd), and lithium ion (Li-ion) electrical cells, have likewise gained increasing acceptance as a renewable power source for these and other devices. Rechargeable batteries are typically well-suited for use in relatively high-drain devices, making them attractive in a wide variety of applications. As they can be recharged and reused, rechargeable batteries can also provide convenience and cost advantages relative to non-rechargeable (primary) batteries.

Of course, a battery charger is needed to recharge the batteries. As rechargeable batteries become more widely adopted, the appearance and functionality of the available chargers become increasingly important. Aesthetics are especially important in applications such as the home or office, as well as in other situations where the appearance of the charger plays a role in a user's decision to employ a particular charger or rechargeable batteries in general. Acceptance is further enhanced where the available chargers are relatively easy to use, particularly by users having little or no experience with battery chargers or electrical devices.

### SUMMARY

Aspects of the present invention address these matters, and others.

According to a first aspect of the present invention, a battery charger includes an electrical plug disposed at a rear of the charger and adapted to engage an AC power outlet, a battery compartment accessible from a front of the charger and adapted to receive at least a first battery for charging, and a user-detachable faceplate which covers at least a portion of the front of the charger.

According to another aspect of the invention, a battery charger includes an electrical plug adapted to engage an AC power outlet, a housing, a battery compartment adapted to receive a plurality of batteries for charging, and a user-replaceable faceplate which covers at least a portion of the exterior of the housing.

According to another aspect of the invention, a battery charger includes an electrical plug (202) disposed at a rear of the charger and adapted to engage an AC power outlet, a battery compartment (104) adapted to receive at least a first battery to be charged, and a user-replaceable, non-planar, decorative skin means (108) for covering at least a portion of the front of the charger.

According to another aspect, a kit includes a battery charger which includes a housing, an electrical plug disposed at a rear of the housing and adapted to engage an AC power outlet, and a battery compartment adapted to receive at least one battery for charging. The kit also includes a plurality of user-replaceable, decorative skins adapted for installation on the housing, whereby the user may alter a decorative appearance of the charger by installing a desired skin.

Those skilled in the art will recognize still other aspects of the present invention upon reading and understanding the attached description.

### BRIEF DESCRIPTION OF THE DRAWINGS

The present invention is illustrated by way of example and not limitation in the figures of the accompanying drawings, in which like references indicate similar elements and in which:

FIG. 1 is a front perspective view of a battery charger.

FIG. 2 is a rear perspective view of a battery charger.

FIG. 3 is a front view of a battery charger with a cover removed for clarity of illustration.

FIG. 4 is a back view of a battery charger.

FIG. 5 is a top view of a battery charger.

FIG. 6 is a bottom view of a battery charger.

FIG. 7 is a first side view of a battery charger.

FIG. 8 is a second side view of a battery charger.

FIG. 9 is a front perspective view of a battery charger with a faceplate detached.

FIG. 10 is a rear perspective view of a battery charger with a faceplate detached.

### DETAILED DESCRIPTION

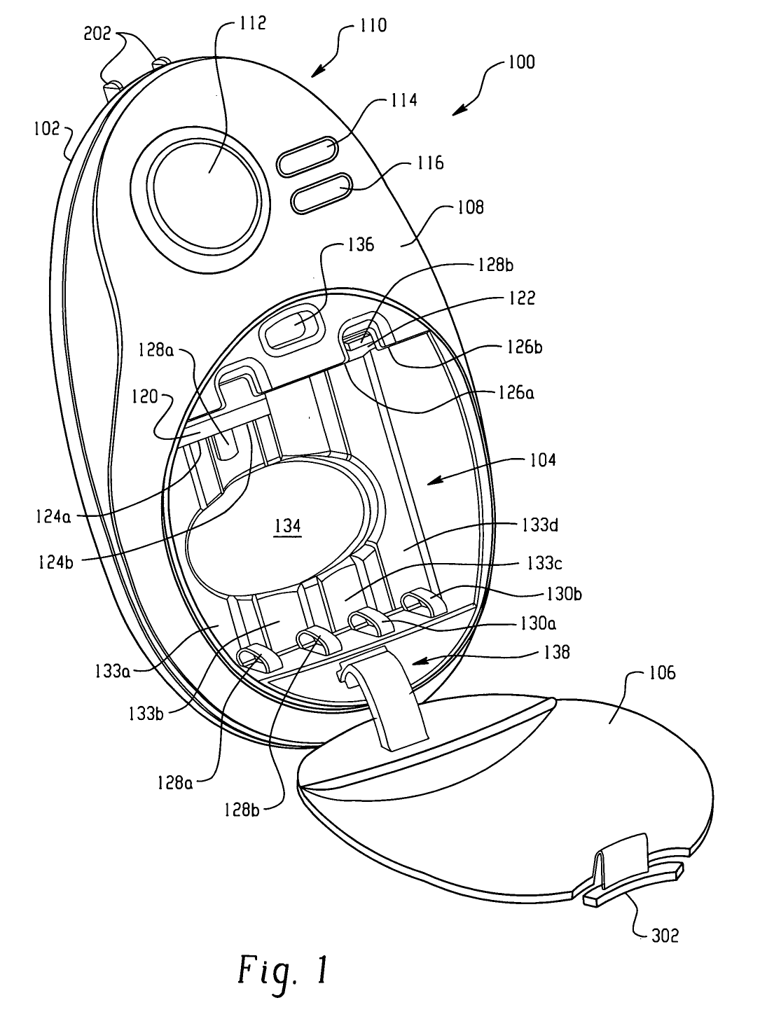

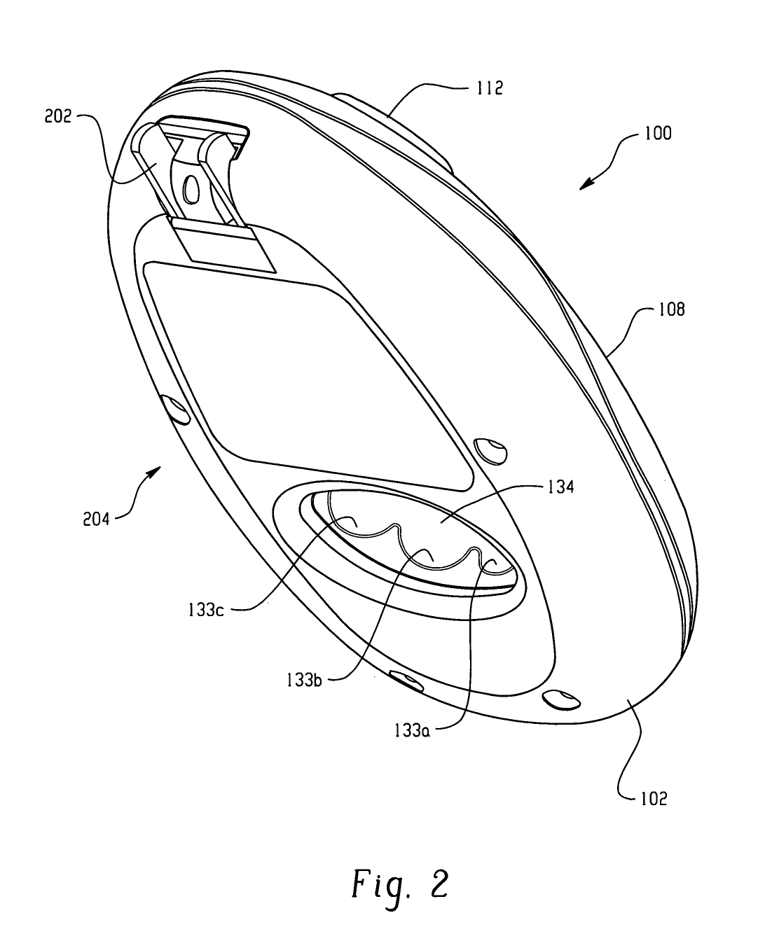

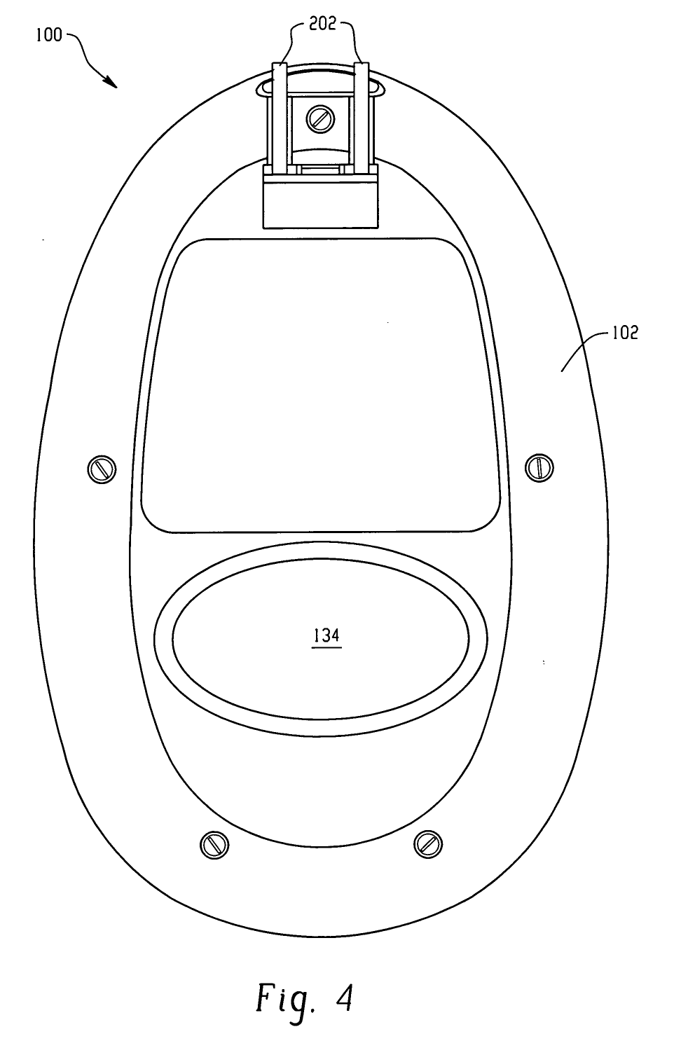

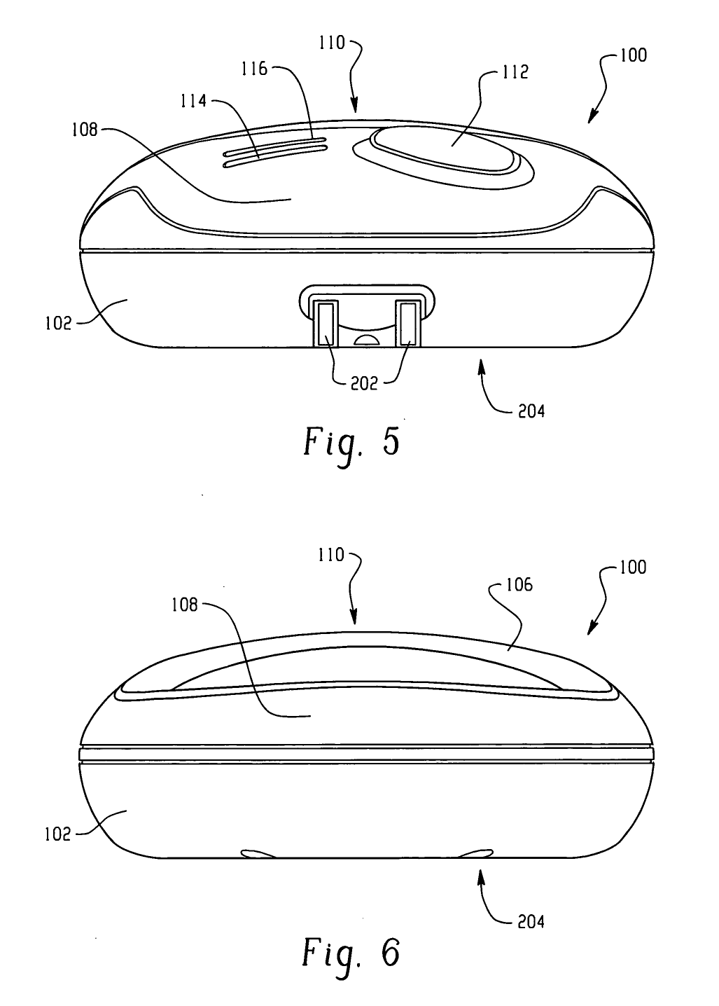

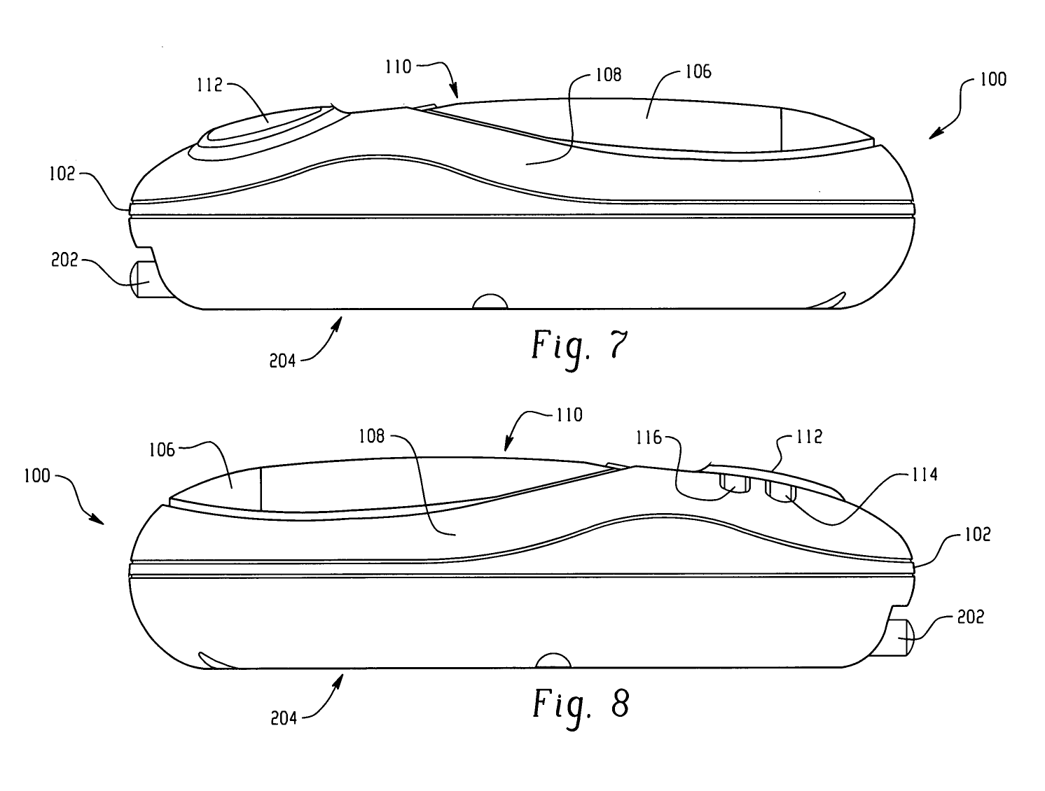

With reference to FIGS. 1 through 8, a battery charger 100 includes a housing 102, a battery compartment 104, a door 106, and a faceplate or skin 108.

While depicted as a single assembly, it will be of course be appreciated that the housing 102 may be fabricated from multiple pieces which are assembled during the manufacturing process to form the housing 102. The housing 102 houses electrical charging circuitry which supplies electrical energy to the battery or batteries being charged. In one embodiment, the charging circuitry is implemented as a timer-based circuit in which the batteries are charged for a pre-selected time period following initiation of a charging cycle. Other charging circuits may also be implemented; various circuits are well known in the art and may be selected based on the number and chemistry of the batteries to be charged and other application specific requirements.

A male electrical plug 202 located to the rear 204 of the housing 102 is preferably mounted for pivotal motion with respect thereto. As illustrated, the plug 202 is configured as a Type A (American 2-pin) plug which connects to nominal 120 volt alternating current (Vac) power mains. Other two or three pin plugs, for example Type C (European 2-pin) plugs, may also be implemented. The electrical plug 202 is preferably movable between a first position which is substantially flush with the rear surface 204 when the charger is not in use and a second position which is substantially perpendicular to the rear 204 of the housing 102 so that the plug 202 can matingly engage a corresponding wall mounted or other power outlet.

Located to the front 110 of the housing 102 are a power switch 112 such as a pushbutton switch and first 114 and second 116 human readable status indicators such as light emitting diodes (LEDs). In one implementation, the power switch 112 is connected electrically in series between the electrical plug 202 and the input of the charging circuit power supply so that the charger 100 is completely de-powered when the switch is in the off position. The first indicator 114 is operatively connected to the charging circuitry and is illuminated to indicate when batteries are being charged. The second indicator 116 is likewise operatively connected to the charging circuitry and is illuminated only when the charging process is complete, at least one battery is installed in the charger 100, and the power switch 112 is in the on position. To more clearly indicate the operating status of the charger, the status indicators 114, 116 may be of different colors. The status indicators 114, 116 may also be overprinted with suitable verbiage such as charging, charge complete, or the like. The verbiage may also be located on the faceplate 108, either alone or in combination with overprinting on the indicators 114, 116. Suitable symbols may also be used, either in addition to or in place of verbiage.

The battery compartment 104 is adapted to receive one or batteries to be charged. First 120 and second 122 contact supports carry respective electrical contacts 124a, 124b and 126a, 126b. The contact supports 120, 122 are preferably mounted for pivotal motion with respect to the battery compartment 104 so that the user may configure the charger to accept batteries of different sizes. As illustrated, the first contact support 120 is disposed in a position which accepts and makes contact with relatively shorter (e.g., AAA size) batteries; the second contact support 122 is disposed in a position which accepts and makes contact with relatively longer (e.g., AA size) batteries. Tabs 128a, 128b are preferably provided to assist the user in pivoting the contact supports 120, 122 to their desired positions.

Spaced apart from the first set of electrical contacts 124a, 124b, 126a, 126b is a corresponding second set of electrical contacts 128a, 128b, 130a, 130b. As will be appreciated, the respective electrical contacts are operatively connected to the charging circuitry so that the terminals of batteries installed in the battery compartment 104 are connected to the charging circuitry. Front facing, generally concave surfaces 133a, 133b, 133c, 133d provide mechanical support for the batteries. As illustrated, the radius of the surfaces 133 is selected to support both AA and AAA size cylindrical batteries. Other suitable electrical contacts and mechanical supports may also be implemented.

Located at the rear of the housing 102 at least partially coextensive with the battery compartment 104 is an aperture 134 configured to facilitate access to the rear of batteries inserted in the battery compartment 104. The aperture 134 is preferably of a size sufficient to allow one or more human fingers to be inserted at least partially therethrough so as to urge the batteries toward the front of the charger 100. The dimensions and location of the aperture 134 are also preferably selected to allow room for concave surfaces 133 or other suitable supports at both ends of the batteries.

In the illustrated embodiment, which in configured to accept up to four (4) AA or AAA size batteries, the aperture 134 is generally oval or elliptical in shape and has a major axis having a length of approximately 1.843 inches (4.68 centimeters) and a minor axis having a length of approximately 0.984 inches (2.50 centimeters). While a single aperture 134 is shown, two or more apertures may also be provided. As one example, a first aperture could be located behind the left most pair of batteries and a second aperture located behind the right most pair. Though illustrated as a material free region, the aperture 134 may also be covered with a flexible material which allows the user to contact the batteries therethrough.

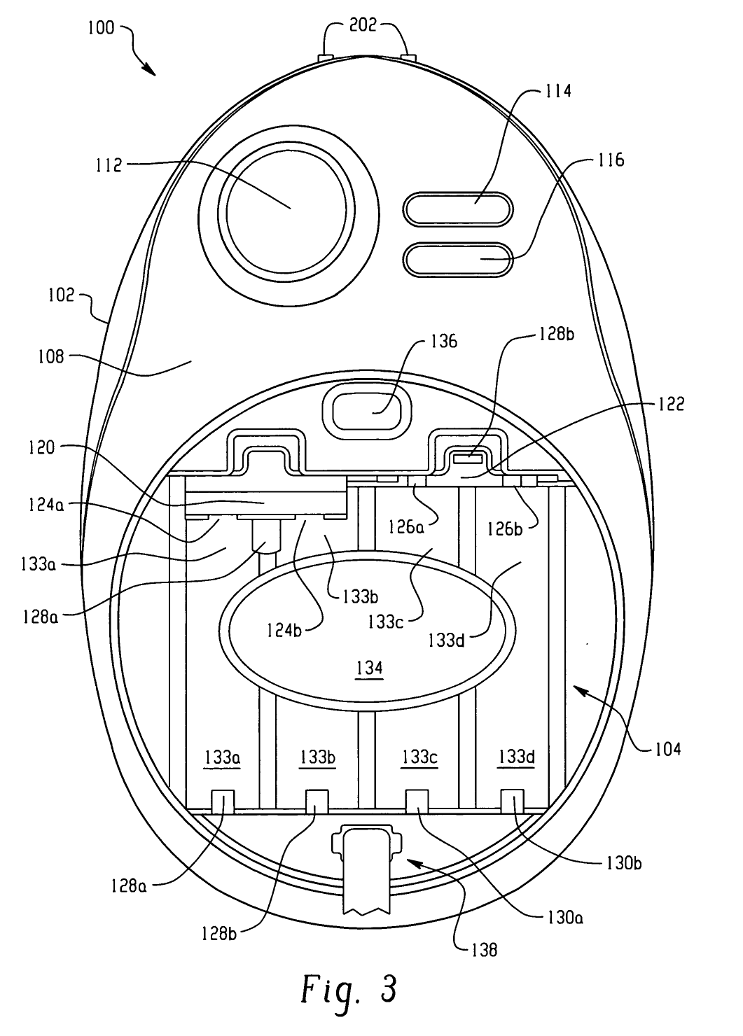

The door 106, which is movably mounted with respect to the housing 102, allows the user to access the battery compartment 104 from the front 110 of the charger 100. In FIG. 1, the door 106 is depicted in an open position which facilitates the insertion and removal of batteries; the cover may likewise be disposed in a closed position as depicted in FIGS. 3 and 5-10. A latch 136 maintains the door 106 in the closed position; a corresponding tab 302 facilitates opening and closing of the door 106. A suitable hinge arrangement 138 allows pivotal motion of the cover with respect to the front of the charger 100.

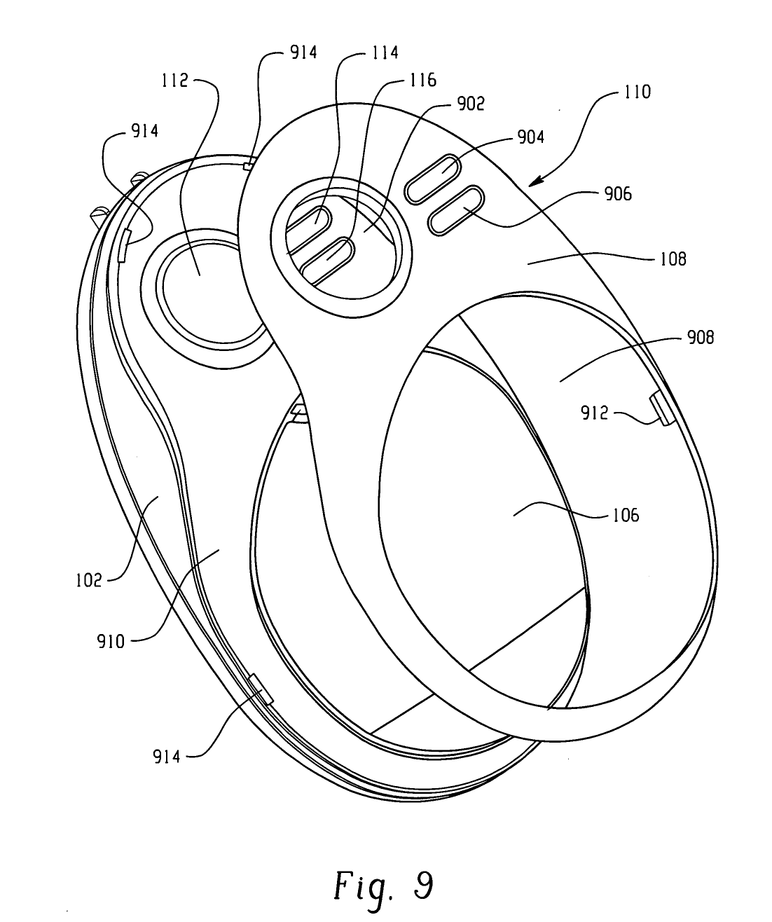

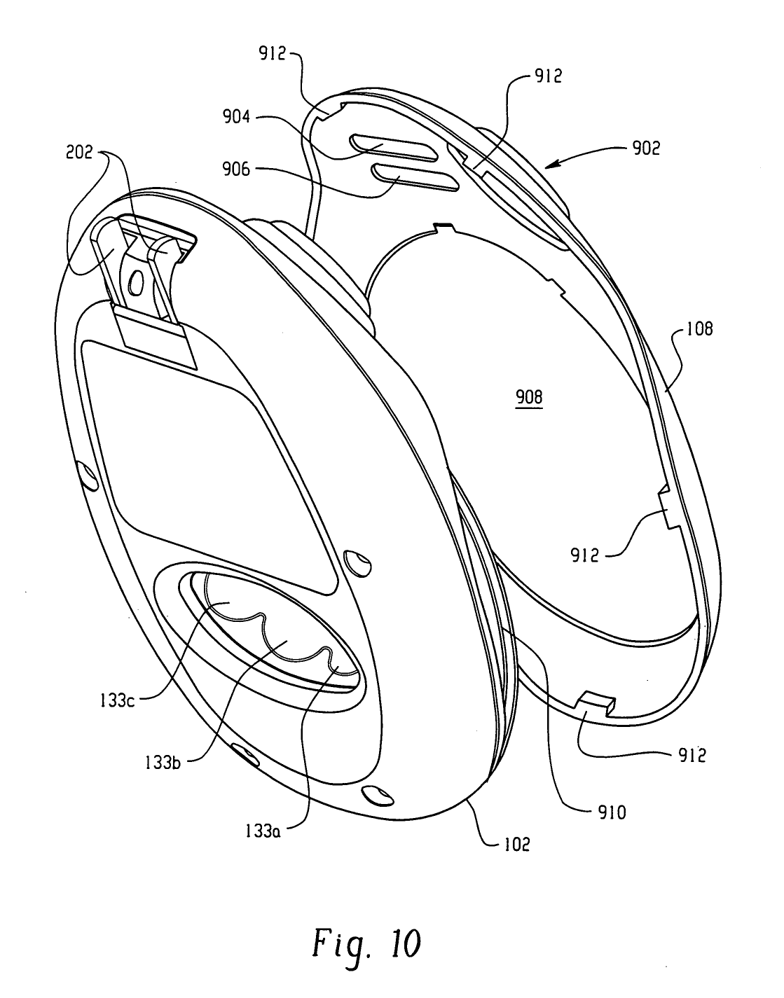

Turning now to FIGS. 9 and 10, the faceplate 108 and housing 102 are advantageously configured so that the faceplate 108 may be readily attached to and/or detached from the charger 100 by a user or other technically unsophisticated person. The relative size and configuration of the faceplate 108 are preferably selected so that the faceplate 108 defines or substantially influences the external appearance of the charger 100, and especially a portion which is visible to the user during normal use or operation.

The housing 102 preferably includes an inner cover portion 910 which restricts access to and otherwise protects the components in the interior of the housing 102 when the faceplate 108 is removed. If fabricated from an optically opaque or translucent material, the inner cover portion 910 may also provide a psychological benefit to technically unsophisticated users.

The faceplate 108 is advantageously fabricated as a relatively thin walled, non-planar skin or shell which substantially conforms to the contour of the inner cover portion 910. If desired, the faceplate 108 may also be configured to provide a contour which differs from that of the inner cover portion 910.

In the illustrated embodiment, the faceplate 108 covers a substantial portion of the front 110 of the charger 100, including the periphery thereof. The faceplate 108 also covers portions of the top, bottom, and sides. The faceplate 108 includes a first aperture 902 which aligns with and allows operation of the switch 112 when the faceplate 108 is installed on the charger. Similarly, first 114 and second 116 indicators are visible through corresponding second 904 and third 906 apertures. A fourth aperture 908 aligns with the door 106 so that the door 106 is operable therethrough. Note that the second 904 and third 906 apertures may be implemented as relatively transparent or translucent regions in the faceplate 108. The first aperture 902 may also be covered with a flexible material which permits operation of the switch 112 therethrough.

Depending on the precise configuration of the charger, more than one switch, indicator, door, or the like may be visible or otherwise operate through a single aperture. The faceplate 108 may also be configured to cover relatively smaller or different portions of the charger 100. In one example, the faceplate 108 may not extend to a region of the housing 102 containing one or more switches, indicators, doors, or the like. In another, an aperture defined by the faceplate may only partially surround one or more of the switches, indicators, or doors. The configuration of the housing 102 and inner cover portion 910 would of course be adjusted accordingly. In any case, it is generally desirable that the various design elements provide an aesthetically desirable or pleasing appearance.

The faceplate 108 includes a plurality of protrusions 912 which snappingly engage corresponding depressions 914 in the housing 102 and thus allow the faceplate 108 to be readily attached to and/or detached from the charger 100. Various attachment techniques are possible. For example, one or more of the protrusions may be located on the housing 102 with corresponding depressions or openings 914 located on the faceplate 108. The faceplate may also be attached magnetically, using hook and loop fasteners, one or more thumbscrews, pushbutton actuated latches, or the like.

Faceplates 108 may be provided in a variety of colors and patterns, surface finishes, or with other suitable ornamentation so that the visual appearance of the charger 100 may be readily altered by changing the faceplate 108. The charger 100 may be packaged as a kit containing a charger 100 and two or more faceplates 108. In one example, each faceplate 108 in the kit is selected to coordinate with a different area in a typical home (e.g., a white or ivory faceplate 108 for use in a typical kitchen, black and/or or silver faceplates for use in an entertainment or computer area, or the like). Moreover, different faceplates 108 or combinations of faceplates 108 may be used to differentiate chargers 100 which are marketed through different sales channels. As still another example, faceplates 108 which appeal to the tastes or interests of different markets or consumer segments may also be provided. Where the faceplates 108 include user readable verbiage or symbols, different faceplate 108 versions can be provided in different languages or with different symbols.

As another variation, the faceplate 108 may be fabricated from a substantially optically transparent or translucent material, with a slight gap between the inner cover portion 910 and faceplate 108. The user may then place a desired decorative material such as wallpaper, cloth, or the like between the inner cover portion 910 and the faceplate 108. Pre-cut materials may also be provided for use by the end user, for example in a kit containing a charger 100, a faceplate 108, and one or more decorative materials.

In operation, the user gains access to the battery compartment 104 by opening the door 106. By adjusting the battery supports 120, 122, the user may configure the charger 100 to accept a battery or batteries of the desired size. Following insertion of the batteries, the user closes the door.

The plug 202 is plugged into a suitable outlet. In such a situation, the rear of the charger 100 typically faces the surface of a wall, outlet strip, or the like which contains the female power outlet. The front and/or one or more of the sides of the charger are typically visible.

Depending on the location and orientation of the outlet and the desires of the user, the batteries may also be inserted before the charger 100 is plugged in. To initiate a charge, the user places the power switch 112 in the on position. The first indicator 114 is illuminated to indicate that charging is under way. Upon completion of a charging cycle, the first indicator 114 is turned off and the second indicator 116 is illuminated to indicate that the charge is complete. Note that the user may use the switch 112 to depower the charger 100 at any time.

To remove the batteries, the user again gains access to the battery compartment 104 by opening the door 106. To assist in removing the batteries, the user may insert one or more fingers through the rear of the aperture 134 to urge the batteries toward the front of the charger 100, through the fourth aperture 908 and out the open door 106. Additional batteries may be charged by repeating the process.

The user may also elect to alter the external appearance of the charger by changing the faceplate 108. The user first unsnaps or otherwise detaches the existing faceplate 108, if any, from the charger 100. A desired faceplate 108 is then snapped or otherwise attached in position on the housing 102. The process may be repeated as desired to further change the appearance of the charger 100.

Note that variations on the charger are possible. While the charger 100 has been described in relation to a charger which accepts up to four (4) AA or AAA batteries, chargers which accept different combinations, numbers, chemistries or sizes of batteries may be implemented. Additional or different switches, displays, or other operator interface elements may also be provided. The door 106 may be omitted, or may be separately replaceable in manner analogous to the faceplate 108. It may also be desirable to implement the door 106 as part of the faceplate 108 so that the appearance of the door 106 and the faceplate 108 may be changed at the same time. The battery charger may also have multiple battery compartments. To enhance portability one or more of the compartments may be implemented as a collapsible or telescoping compartment or bay which extends from the top, bottom, or side of the housing 102 when in use. To enhance accessibility, the housing or bay is preferably accessed from a front of the charger.

Note that, unless otherwise indicated to the contrary, the terms top, bottom, front, rear, and side have used in relation to the charger 100 itself. As will be appreciated, electrical outlets can be installed in various orientations. Thus, the orientation of the charger 100 may not necessarily correspond to the orientation of the charger in the physical environment.

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A battery charger comprising:
an electrical plug (202) disposed at a rear of the charger and adapted to engage an AC power outlet;
a battery compartment (104) accessible from a front of the charger and adapted to receive at least a first battery for charging;
a user-detachable faceplate (108) which covers at least a portion of the front of the charger.

2. The charger of claim 1 wherein the faceplate (108) includes a first aperture (908), and wherein the battery compartment is accessible through the first aperture.

3. The charger of claim 2 wherein the charger includes a door (106) and wherein the door allows the user to selectively access the battery compartment.

4. The charger of claim 1 wherein the charger includes a human readable status indicator (114, 116) which indicates an operating status of the charger, wherein the faceplate (108) includes an aperture (906), and wherein the status indicator is visible through the aperture.

5. The charger of claim 1 wherein the charger includes a housing (102), a component carried by the housing, and an inner cover portion (910) which covers the component when the faceplate is detached from the charger.

6. The charger of claim 5 wherein the inner cover portion has a non-planar surface contour and wherein the faceplate has a surface contour which substantially conforms to the surface contour of the inner cover portion.

7. The charger of claim 6 wherein the faceplate snappingly engages the housing.

8. A battery charger comprising:
an electrical plug (202) adapted to engage an AC power outlet;
a housing (102);
a battery compartment (104) adapted to receive a plurality of batteries for charging;
a user-replaceable outer cover (108) which covers at least a portion of the exterior of the housing.

9. The charger of claim 8 wherein the charger includes a user-operable switch (112), wherein the outer cover (108) includes an aperture (902), and wherein the switch is operable through the aperture.

10. The apparatus of claim 8 wherein the battery compartment is accessible from a front of the charger and the outer cover covers at least a portion of the front of the charger.

11. The apparatus of claim 10 wherein the outer cover surrounds a front periphery of the battery compartment.

12. The apparatus of claim 10 including a door (106) movably mounted to the housing so as to allow a user to selectively access the battery compartment.

13. A battery charger comprising:
an electrical plug (202) disposed at a rear of the charger and adapted to engage an AC power outlet;
a battery compartment (104) adapted to receive at least a first battery to be charged;
user-replaceable, non-planar, decorative skin means (108) for covering at least a portion of the front of the charger.

14. The battery charger of claim 13 wherein the skin means includes aperture means (908) for allowing a user to access the battery compartment (104).

15. The battery charger of claim 13 wherein the skin means covers at least a portion of a side of the charger.

16. The apparatus of claim 13 wherein the skin means is snappingly attachable to the charger.

17. A kit comprising:
a battery charger including:
a housing (102);
an electrical plug (202) disposed at a rear of the housing and adapted to engage an AC power outlet;
a battery compartment (104) adapted to receive at least one battery for charging;
a plurality of user-replaceable, decorative skins (108) adapted for installation on the housing, whereby the user may alter a decorative appearance of the charger by installing a desired skin.

18. The kit of claim 17 wherein the skins have non-planar surface contours.

19. The kit of claim 18 wherein the housing includes an inner cover (910) having an outer surface contour and wherein the surface contour of the skins substantially conforms to the outer surface contour of the inner cover.

20. The kit of claim 17 wherein the skins snappingly engage the housing.

21. The kit of claim 20 wherein each skin is a different color.

22. The kit of claim 17 wherein the each skin includes a first aperture (908) and wherein the battery compartment (104) is accessible through the first aperture when a skin is installed on the housing.

23. The kit of claim 22 wherein the charger includes a battery compartment door (106) and wherein the door is operable through the first aperture.

24. The kit of claim 22 wherein the battery compartment is accessible from a front of the charger and wherein the skins cover at least a portion of the front of the charger.

25. The kit of claim 22 wherein the battery compartment receives AA and AAA size batteries.
